(19) United States
(12) Patent Application Publication
(10) Pub. No.: US 2004/0131805 A1
(43) Pub. Date: Jul. 8, 2004

(54) Films having a desiccant material incorporated therein and methods of use and manufacture

(76) Inventors: Rick L. Merical, Appleton, WI (US); Lee J. Murray, Appleton, WI (US)

Correspondence Address: Stephen T. Scherrer, McDermott, Will & Emery, 227 West Monroe Street, Chicago, IL, 60606-5096, US

(21) Appl. No.: 10/385,131

(22) Filed: Mar. 10, 2003

Related U.S. Application Data
(63) Continuation-in-part of application No. 10/175,662, filed on Jun. 20, 2002.

(51) Int. Cl. F16L 1/00

(52) U.S. Cl. 428/34.1

(57) ABSTRACT

Film structures, packages and methods of making the same are provided wherein the film structures have a desiccant material incorporated into a sealant layer of the film structures and further wherein the sealant layer of the film structures comprise a material for making a peelable seal when the film structures are heat sealed to other film structures. The film structure is utilized for a package to hold a product that may be sensitive to the presence of moisture. The product may preferably be pharmaceutical or nutriceutical products, although any moisture-sensitive product is contemplated by the present invention.

### FIELD OF THE INVENTION

The present invention relates to a film having a desiccant material incorporated therein. More specifically, the present invention relates to a film structure having a desiccant material within a sealant layer of the film structure wherein said film structure is utilized in a package for a product that may be sensitive to the presence of moisture. In addition, the present invention relates to methods of manufacturing and methods of using the film having a desiccant material incorporated therein.

### BACKGROUND OF THE INVENTION

It is generally known to utilize plastic packaging to reduce exposure of products to atmospheric conditions, such as to moisture or oxygen, which may damage the products. For example, packaging for foodstuffs is well known, in that moisture and oxygen may cause the foodstuffs to become spoiled and inedible or otherwise undesirable. In addition, many products in the medical field, such as pharmaceutical and nutriceutical products, may also be very sensitive to atmospheric moisture.

Typically, moisture-sensitive products may be encased in thermoplastic material that is relatively impermeable to water molecules. Specifically, many polymeric materials are utilized as barriers to moisture transmission. For example, a film of high density polyethylene (HDPE), or polyvinylidene chloride-methyl acrylate (PVdC-MA) copolymer may be utilized to restrict the movement of water molecules through the film. Oriented polypropylene, metallized oriented polypropylene, or metallized polyester would also be useful as moisture barrier material. In addition, metal foil is known to prevent the transmission of oxygen and/or moisture through polymeric packaging having a layer of metal foil contained therein.

Although these moisture barrier polymers may be useful in restricting the movement of moisture into a package, some moisture molecules can still make their way into the package to deleteriously affect the product contained therein. In addition, even when barrier materials are effective at restricting the transmission of water molecules through a package, certain features of the package may still allow for the transmission of water molecules. For example, where a barrier material is incorporated into a central layer of a film structure and the film structure is sealed to another film structure having a barrier material as a central layer, the edges of the package may not be protected by the barrier layers. This may allow moisture to make its way into a package along the edges of a heat sealed package.

One solution to maintaining a particularly low or virtually nonexistent level of moisture within a package is to incorporate sachets of desiccant material into the internal space of the package to remove the moisture from the headspace of the package. A sachet may effectively maintain a very low level of moisture in internal spaces of packages, but may have difficulty maintaining the same consistent moisture levels after the package has been opened and a product has been removed. For example, a typical package of moisture-sensitive products may contain a plurality of the products. A sachet of desiccant material incorporated into the package may only guarantee that moisture level of the package is maintained at a constant or minimal moisture level until the package is opened and the first product is thereby removed. The remaining products will be instantly exposed to atmospheric moisture when the seal of the package is broken. Although the sachet may remove some moisture from the headspace of the package after the package is opened, the remaining moisture-sensitive products, having already been exposed to moisture, may already be damaged. This may be especially true in bulk packaged materials where sachets are most often used. Desiccant materials are typically incorporated into liddings of jars or in sachets of multi-unit packages.

In addition, sachets of desiccant material may become saturated with atmospheric moisture relatively quickly thereby decreasing or eliminating their effectiveness. Moisture-sensitive products, therefore, stand a greater chance of being damaged by moisture in this case.

Moreover, the desiccant material contained in the sachets is typically in powder or granular form and may leak or otherwise spill from the sachets thereby contaminating the product or products contained within the package. For example, if the desiccant material contacts a food, pharmaceutical or nutriceutical product or medical device, the food, pharmaceutical or nutriceutical product or medical device may become contaminated with the desiccant material, which may be damaging to the health of an individual that consumes the food product or uses the medical device.

Additionally, although desiccant material is generally known to reduce the moisture content within a package, typical desiccant materials are “physical” desiccant materials, such as molecular sieves, that bind water molecules within pore spaces of a material. Typically, physical desiccant materials absorb water at all humidity levels, but will cease to absorb water when interstices of the physical desiccant material are filled. Therefore, physical desiccant materials may be ineffective at high humidity levels.

An additional type of desiccant material may be hydrate forming agents such as salts. Typical salts that may be utilized as desiccant material are magnesium sulfate, sodium phosphate di-basic, ammonium chloride, potassium carbonate, potassium aluminum disulfate, magnesium chloride, diammonium sulfate, sodium nitrate, calcium chloride, and calcium sulfate, although many others are known as well. Typically, the drying capacity is greatly influenced by the relative humidity within a package. Generally, no water is taken up by the hydrate-forming agent until the relative humidity reaches a value at which the first hydrate forms. In the case of calcium chloride, for example, the first hydrate occurs at less than about two percent relative humidity (R.H.). Water is then taken up by the hydrate forming salt until the first hydrate is completely formed by the salt. No further water is taken up by the salt until the relative humidity reaches a second level where the second hydrate forms. This process continues through as many hydrates as the agent forms at which point the substance begins to dissolve and a saturated solution is formed. The saturated solution will then continue to take up water.

Although these salts may be effective at removing water molecules from a quantity of gas that may be contained within the headspace of a package, since the salt only binds the water molecules within the salt, the water molecules may easily escape back into the package. This is known as breathing, and may cause deliquescence (water droplets and liquidization) inside the package. Typically, this can happen if the salt becomes saturated and if the temperature of the package increases, or if the pressure of the package decreases, which may occur during shipment or storage of the package.

In addition, salts may not allow moisture levels within a package to fall to a level that is necessary to protect the moisture-sensitive product that may be contained within the package. Typically, since salts have different levels of hydration, humidity levels may remain at certain level without decreasing until the level of hydration changes.

However, these salts may be utilized to maintain certain humidity levels within the headspace of a package. For example, certain products may require that a certain level of moisture or humidity be maintained within the package headspace. Headspace humidity control for products can be manipulated by incorporation of the appropriate hydrate forming agents.

Desiccant materials may also be used that form no hydrates, such as common salt (NaCl) or potassium bromide (KBr). For example, common salt will absorb no water at a relative humidity below about 75 percent. When 75 percent relative humidity is reached, a saturated solution is formed which continues to take up water.

The present invention may utilize chemical desiccant technology, which is more preferable because the moisture level within a package may be maintained at an extremely low level. Chemical desiccant materials chemically react with water molecules to form a new product, wherein the water molecules are chemically incorporated into the new product. For example, calcium oxide binds water in the following reaction:

CaO+H₂O→Ca(OH)₂

Because the reaction noted above requires very high energy levels to reverse, it is, for all practical purposes, irreversible. Chemical desiccant materials typically absorb water at all humidity levels, and will continue to take up water at high relative humidity levels. These chemical desiccant materials, therefore, may reduce levels of moisture within the package headspace to zero or near zero, which is often desired to maintain maximum dryness of the product.

An example of a moisture-sensitive product that would benefit from the present invention are medical diagnostic testing equipment, such as diagnostic test strips. Medical diagnostic test strips are typically used to test for the presence of particular compounds in a biological fluid, such as blood or urine. For example, diagnostic test strips may detect the presence of narcotics or other substances.

A diagnostic test strip is typically dipped into a sample of the biological fluid and if the individual has traces of narcotics in the sample of the biological fluid then the diagnostic test strip may change colors to indicate the presence of the narcotics.

In addition, diagnostic test strips may be useful to detect particular levels of naturally occurring compounds that may be present within biological fluids. For example, high levels of protein in blood and/or urine may indicate a disease state. Diagnostic strips are useful to test not only for protein levels, but a plurality of other indicators for levels of various disease indicators. Diagnostic strips may also be utilized to detect certain biological conditions, such as pregnancy.

Diagnostic strips, like the ones described above, are typically extremely sensitive to moisture, and must be removed from atmospheric conditions in order to work properly. In the medical field, it is extremely important to get accurate readings using diagnostic testing strips. An inaccurate reading may make it difficult to diagnose a particular disease state, or may make a doctor misdiagnose a particular disease-state entirely. In addition, an inaccurate reading may jeopardize an individual that may test positive for a particular narcotic, especially if the positive result is a false reading. Therefore, it is of utmost importance that diagnostic strips be as accurate as possible.

Therefore, diagnostic test strips are typically sealed away from atmospheric conditions. For example, diagnostic test strips are typically wrapped or otherwise contained within a material that is impervious to moisture and oxygen that may cause damage to the diagnostic test strips. A thick plastic or glass plastic package, jar, vial or other container is typically used to house diagnostic test strips prior to use. In addition, sachets of desiccant material are typically incorporated into packaging for diagnostic test strips. However, these packages suffer from the problems as detailed above.

Moreover, other examples of moisture-sensitive products that would benefit from the present invention are pharmaceutical and/or nutriceutical products, such as pills, tablets, and other like pharmaceutical or nutriceutical products, that may be contained within a bottle, or may be individually packaged in individual cavities that have been thermoformed or otherwise disposed within a sheet of packaging materials. For example, the pills, tablets or other pharmaceutical or nutriceutical products may be contained within multi-unit packages, wherein a rigid or semi-rigid base structure having multiple cavities contains a plurality of pills, tablets, or other pharmaceutical or nutriceutical products. A film or sheet of a multilayer film structure may then be disposed as lidstock over the rigid or semi-rigid base structure to seal the cells containing the pills, tablets or other pharmaceutical or nutriceutical delivery systems. Alternatively, individual cavities for pharmaceutical or nutriceutical pills or tablets may be formed by heat-sealing two flexible films together completely around one or more pharmaceutical or nutriceutical pills or tablets.

Other examples of typical packages or products that would benefit from desiccant material are other medical kits, such as home pregnancy test kits and medical instruments. In addition, other products include electrostatic shielding packaging for electronic parts, such as printer cartridges, circuit boards, televisions, DVDs, printers, modems, personal computers, and telecommunications equipment, etc. Further, other packaging that would benefit from desiccant material is packaging for foods, such as cheese, peanuts, coffee, tea, crackers, spices, flour, bread, etc. In addition, other products that would benefit from desiccant material incorporated into the packaging are shoes, boots, film products and cameras, and products that may be shipped by sea, such as high-value wood like mahogany that would be damaged if exposed to ambient humidity typically found in cargo ships.

A need, therefore, exists for polymeric plastic packaging that may be used in packaging to preserve products that may be sensitive to atmospheric moisture. The packaging may comprise films having a desiccant material incorporated directly into a sealant layer of the film. In addition, films are needed that effectively control the level of moisture within packaging without using sachets or desiccant beads that may become ineffective over time, or that may contaminate products contained within the packaging. Moreover, films, methods of use and manufacture are needed to overcome the additional disadvantages as noted above with respect to sachets, beads or physical desiccants.

### SUMMARY OF THE INVENTION

The present invention relates to multilayer plastic polymeric flexible packaging films having a desiccant material incorporated within a layer of the film. More specifically, the present invention relates to a polymeric flexible film having a desiccant material incorporated within a layer of the film that is utilized as a package for a product that may be sensitive to the presence of moisture. In addition, the present invention relates to methods of manufacturing and using the polymeric film having a desiccant material incorporated therein.

It is, therefore, an advantage of the present invention, to provide a polymeric plastic packaging film having a desiccant material incorporated therein for packages that may contain moisture sensitive products. These products may be, for example, foodstuffs, pharmaceutical and/or nutriceutical products and/or other products that may suffer from the deleterious effects of moisture. Specifically, pharmaceutical and/or nutriceutical products that are useful in healthcare may be packaged using a film having a desiccant material contained within a layer of the film to maintain the utility of the pharmaceutical or nutriceutical products. The desiccant material is utilized to control the moisture level within a package made by the film of the present invention.

In addition, it is an advantage of the present invention to provide a film having a desiccant material incorporated therein that would eliminate the need to incorporate into high cost and marginally effective sachets or beads of desiccant material that can contaminate products contained within packages if the sachets accidentally release the desiccant material into the package. Moreover, sachets or beads are typically higher in cost and may be relatively unsightly. Further, they may take up space within a package that could otherwise be used for product. If the desiccant material within the sachets or beads are ingested, it may become a health hazard. By the present invention, the desiccant material is incorporated directly into the packaging film in a rigid solid state in the packaging film substrate.

Moreover, it is an advantage of the present invention to provide a film wherein the desiccant material is incorporated into the sealant layer of the film and wherein the film is easily extruded. In addition, many different types of desiccant materials may be utilized, thereby allowing for particular relative humidity levels within the packages.

The present invention further reduces packaging costs by allowing for the use of thinner and, therefore, less expensive barrier materials, such as aluminum foil. For example, many flexible foil packages made using films of the present invention can have barrier layers having thicknesses that may be reduced by about 50% or more. Moisture can enter a package through a film structure where two film structures are heat-sealed together. The present invention reduces the moisture absorption by blocking this entry point.

In addition, it is an advantage of the present invention to provide a film structure, and a package made therefrom, comprising a sealant film having a desiccant material and a peelable seal material that allows the film structure to be easily peeled from another film structure when the film structure is heat sealed to the other film structure. This allows moisture-sensitive products to be contained within a package and be protected from moisture while being easily openable.

Additional features and advantages of the present invention are described in, and will be apparent from, the detailed description of the presently preferred embodiments and from the drawings.

### BRIEF DESCRIPTION OF THE DRAWINGS

FIG. 1 illustrates a cross-section of a film of the present invention comprising a desiccant material incorporated therein in an embodiment of the present invention.

FIG. 2 illustrates a cross-sectional view of a film structure having a film layer comprising a desiccant material incorporated therein in another embodiment of the present invention.

FIG. 3 illustrates a perspective view of a package made by the film structure in an alternate embodiment of the present invention.

FIG. 4 illustrates a cross-sectional view of the package along line IV-IV, in the alternate embodiment of the present invention.

FIG. 5 illustrates a perspective view of an alternate package comprising a desiccant sealant film of the present invention.

FIG. 6 illustrates a cross-sectional view of the package of FIG. 5 of the present invention along line VI-VI.

FIG. 7 illustrates a perspective view of an alternate package comprising a desiccant sealant film of the present invention.

FIG. 8 illustrates a cross-sectional view of the package of FIG. 7 of the present invention along line VIII-VIII.

### DETAILED DESCRIPTION OF THE PRESENTLY PREFERRED EMBODIMENTS

The present invention relates to films, film structures, packages and methods of using and/or manufacturing the films, film structures and packages of the present invention. Specifically, the films comprise a desiccant material incorporated into the films as an integrated component. More specifically, the desiccant material is contained within a heat sealant layer of a film structure. The film structure may be utilized to produce a package for a moisture-sensitive product wherein said package has a first film structure in face-to-face contact with a second film structure and wherein said film structures are heat sealed together around the edges of the package while the product is contained therein. Although many types of moisture-sensitive products may be contained within the packages made from the films or film structures of the present invention, the packages made therefrom are especially useful for packaging diagnostic test strips, medical kits, instruments, and pharmaceutical and/or nutriceutical packaging.

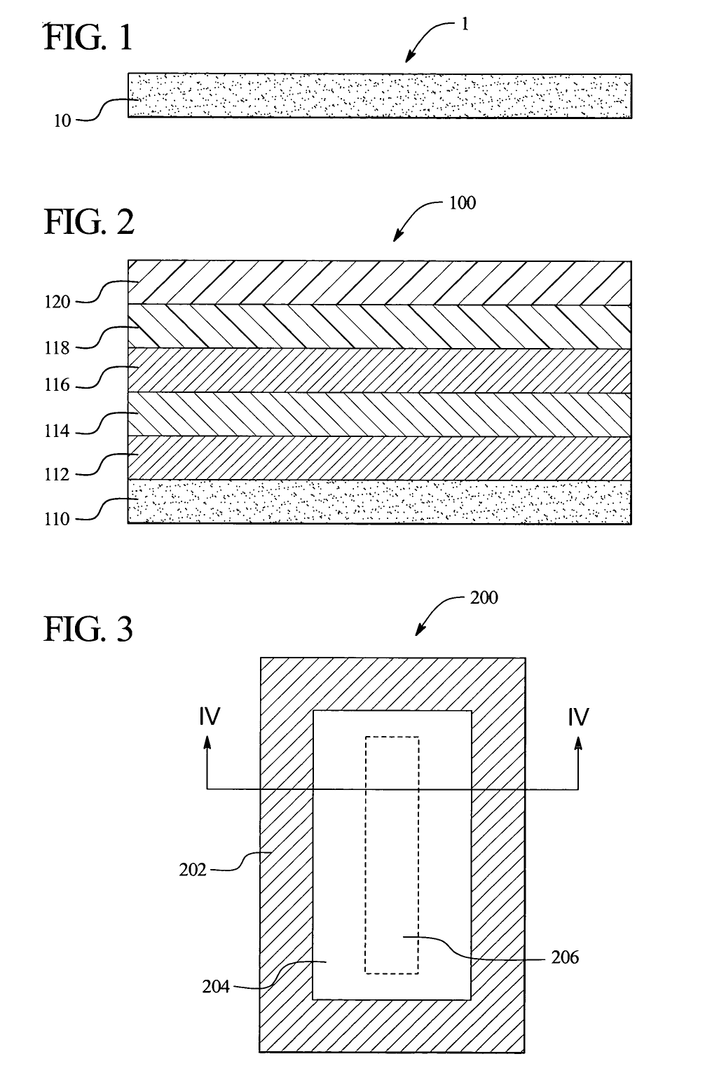

Now referring to the drawings, wherein like numerals refer to like parts, FIG. 1 illustrates a film 1 of the present invention. The film 1 may be made from a polymeric material, such as a polyolefinic material. Preferably, the film may comprise polyethylene selected from the group consisting of ultra low density polyethylene, low density polyethylene, linear low density polyethylene, medium density polyethylene, and high density polyethylene, and may be made via any known method of making polyethylene, such as via Ziegler-Natta catalysts, or single-site catalysts, such as metallocene catalysts. Moreover, the film may preferably comprise ethylene copolymers, such as ethylene alpha-olefin copolymers, ethylene-methyl acrylate copolymer, ethylene vinyl acetate copolymer, ethylene acrylic acid copolymer, ethylene methyl acrylic acid copolymer, ionomer (Surlyn), and other like polymers. In addition, the film may comprise polypropylene homopolymer or copolymer, either alone or blended with polyethylene or polyethylene copolymers, as noted above. In addition, the film may comprise modified polymeric materials, such as modified via maleic anhydride, or other like modifiers for polymeric materials having particular characteristics. Specific materials that may be useful as the sealant layer include DuPont APPEEL® and BYNEL®.

The film 1 may further comprise a desiccant material 10 blended therein, such as any known desiccant material that may blend with polymeric resins that can be made into films. Specifically, desiccant materials that may be useful for the present invention include, but are not limited to calcium oxide, magnesium oxide, barium oxide, strontium oxide, aluminum oxide, partially hydrated aluminum oxide, magnesium sulfate, sodium phosphate di-basic, ammonium chloride, potassium carbonate, potassium aluminum disulfate, magnesium chloride, diammonium sulfate, sodium nitrate, calcium chloride, calcium sulfate, sodium chloride, potassium bromide, molecular sieves, clays, or any other desiccant material useful for the present invention. Chemical desiccant materials are preferred, such as calcium oxide, magnesium oxide, barium oxide and strontium oxide.

Chemical desiccant materials are preferred because chemical desiccant materials irreversibly bind water molecules within the crystalline product via a chemical reaction. The water molecules typically cannot be released into the package at higher temperatures or lower pressures. In addition, chemical desiccant materials may more effectively remove humidity from the headspace of a package made from the film 1.

Hydrate-forming salts may also be used, and may effectively maintain constant relative humidity levels within the headspace of a package made from the film 1. For example, magnesium sulfate may be blended with polyethylene or another polymeric material to form a package that may maintain a relative humidity level inside said package at about 35%. However, other levels of humidity may be maintained depending on the hydration levels or state of the magnesium sulfate within the polymer material.

A preferred chemical desiccant material that is useful for the present invention is calcium oxide. Another preferred chemical desiccant material is barium oxide, which irreversibly forms barium hydroxide via a chemical reaction. In addition, the barium hydroxide can further be utilized as a desiccant material because the barium hydroxide can be utilized as a hydrate forming desiccant mateiral wherein the barium hydroxide may form coordinated structure with eight water molecules at various humidity levels.

The desiccant material can be incorporated into the film 1 at a level of between about one weight percent and about 90 weight percent. More preferably, the desiccant material can be incorporated into the film 1 at a level of between about 20 weight percent and about 60 weight percent. Most preferably, the desiccant material can be incorporated into the film 1 at a level of about 30 weight percent.

Specifically, the film 1 may comprise a quantity of a masterbatch of polymer and desiccant material. For example, the masterbatch may preferably comprise polyethylene having calcium oxide blended therein. Specifically, the masterbatch comprises about 50 percent by weight polyethylene and about 50 percent by weight calcium oxide. The masterbatch is further blended into another polymeric material, such as low density polyethylene, in a ratio of about 60 percent by weight masterbatch and 40 percent by weight low density polyethylene. Therefore, the film 1 may preferably have a desiccant material content of about 30 weight percent in the film 1. Alternatively, the masterbatch is blended with a modified ethylene vinyl acetate copolymer or modified ethylene methyl acrylate copolymer, such as DuPont APPEEL® resins, to provide the sealant film structures with a peelable seal feature.

It should be noted that although the film 1 is illustrated as a single independent layer, film 1 may be incorporated into a multilayer structure such as via coextrusion with other film layers, extrusion or coextrusion coating, adhesive lamination, extrusion lamination or any other method of making multilayer film structures having a sealant layer comprising a desiccant material with other film layers.

FIG. 2 illustrates a film structure 100 of the present invention, incorporating a film layer 110 having a desiccant material incorporated therein, as detailed above with relation to the film 1. Specifically, the film layer 110 may comprise a polyolefinic material, such as polyethylene, as described above, or polypropylene. Preferably, the polyolefinic material comprises polyethylene. The desiccant material may comprise a chemical, physical, or hydrate-forming desiccant material, although a chemical desiccant material is preferred.

In addition, the film layer 110 may be between about 1 mil and about 10 mils thick and may form a sealant layer or a product contacting layer in a package made from the film structure 100. More preferably, the film layer 110 may be between about 1 mil and 5 mils thick. Most preferably, the film layer 110 can be between about 1.5 mils and about 3.5 mils thick.

The film layer 110 may further comprise a component that provides a peelable seal when used as a sealant layer that is heat sealed to another film structure or to itself. A preferable resin blend that allows for a peelable seal is DuPont APPEEL®, which is either modified ethylene vinyl acetate copolymer or modified ethylene methyl acrylate copolymer, each of which is designed to provide a peelable seal when heat-sealed to other film layers, such as polyvinylchloride (PVC). Alternatively, a seal-poisoning component may be utilized, wherein a material, such as polybutylene, may be blended with the sealant resins to provide “poisoned seals” when sealant layers made from such resins are heat-sealed to other film layers, which can provide adequate sealing protection but can be easily separable using digital pull-apart forces. In addition, a desiccant material, such as calcium oxide (CaO) can be used as the peelable seal component, such that when heat-sealed to another film component, the film structure may be relatively easily separable using digital pull-apart forces.

The material that provides the peelable seal, such as DuPont APPEEL®, may be present in the film structure at a weight percent of between about 20 and about 60 weight percent of the film layer 110. More preferably, the peelable seal component may be present in the film structure at between about 30 and about 50 weight percent of the film layer 110. Most preferably, the peelable seal component may be present in the film structure at about 40 weight percent of the film layer 110. The peelable seal component may be blended with another sealant layer resin, such as PVC, polyethylene terephthalate (PET), and polyethylene, such as polyethylene that is selected from the group consisting of ultra low density polyethylene, low density polyethylene, linear low density polyethylene, medium density polyethylene, and high density polyethylene. Further, the polyethylene may be made via any known method of making polyethylene, such as via Ziegler-Natta catalysts, or single-site catalysts, such as metallocene catalysts. Moreover, the other sealant layer resin may comprise ethylene copolymers, such as ethylene alpha-olefin copolymers, ethylene-methyl acrylate copolymer, ethylene vinyl acetate copolymer, ethylene acrylic acid copolymer, ethylene methyl acrylic acid copolymer, ionomer (Surlyn), and other like polymers. In addition, the other sealant layer resin may comprise polypropylene homopolymer or copolymer, either alone or blended with polyethylene or polyethylene copolymers, as noted above.

Alternatively, the peelable seal component may not be present in the heat sealant layer, as described above, but may be present in a heat sealable layer of a second film structure that is heat-sealed to the film structure containing the desiccant material. This allows the peelable film component to be present in either the film structure containing the desiccant material or the second film structure that the film structure containing the desiccant material is heat-sealed to. In addition, the peelable seal component of the present invention may be contained within the first tie layer of the film structure containing the desiccant material, or alternatively, to a tie layer of the second film structure that the film structure containing the desiccant material is heat-sealed to. Therefore, it should be noted that the peelable film component can be contained within any layer or any film structure that allows the film structure containing the desiccant material to be pulled from the second film structure with digital pull-apart forces, while maintaining protection from moisture prior to pulling the film structures apart.

The remaining film layers of a film structure of the present invention may be any material that may be utilized to form a package with the film layer 110 as a sealant layer or a product contacting layer. Moreover, any number of layers may be incorporated into the film structure 100 as may be needed to form a package having desired characteristics. The preferred film structure of the present invention includes the heat sealant layer 110, as noted above. The heat sealant layer 110 may be adhered to a barrier layer 114 by a tie or adhesive layer 112. In addition, the film structure 100 may comprise an outer layer 120 adhered to said barrier layer via a second tie or adhesive layer 116 disposed between said outer layer 120 and said barrier layer 114. Finally, the film structure 100 of the present invention may comprise a primer layer or printed layer 118 disposed between said outer layer 120 and said tie adhesive layer 116.

Preferably, tie or adhesive layer 112 may be a coextrusion of low density polyethylene (LDPE) and ethylene acrylic acid copolymer (EAA), wherein said LDPE is disposed adjacent to the sealant layer 110 and the EAA is disposed adjacent to the barrier layer 114, as described below, although other polymeric materials may be utilized that adhere the heat sealant layer 110 to the barrier layer 114. Barrier layer 114 may be made of a polyvinylidene chloride-methyl acrylate copolymer, Honeywell ACLAR® (a high density fluorocarbon polymer), metal foil, such as aluminum foil, nylon, high density polyethylene, polypropylene, such as oriented polypropylene and metallized oriented polypropylene, or metallized polyester, and may be any thickness that may be necessary to reduce the transmission of water molecules through the film structure 100. Preferably, the barrier layer 114 may be about 0.35 mils when the barrier layer 114 is aluminum foil. Of course, the barrier layer may be other thicknesses depending on the barrier material that is utilized. The tie or adhesive layer 112 may aid in binding the polyolefinic material of the heat sealant layer to metal foil that may be used as the barrier layer 114. Tie or adhesive layer 116 may be a coextrusion of LDPE and EAA and may be similar, if not identical, to film layer 112, wherein the EAA is disposed adjacent to the barrier layer 114, and the LDPE is disposed adjance to the film layer 118 or film layer 120, as described below. Film layer 118 may be a primer layer and/or a printed layer. If the film layer 118 is a printed ink or pigment layer, it may form a printed label or other printed indicia on the film structure 100. Finally, film layer 120 may be an outer abuse layer, and may comprise Honeywell ACLAR®, polyethylene terephthalate (PET), oriented polypropylene (OPP), polyethylene, nylon, foil, metallized substrates, or any other material apparent to one having ordinary skill in the art. Optionally, a secondary sealant layer (not shown) may be disposed adjacent to the sealant layer 110 and may protect the product from the desiccant material contained in the sealant layer 110. The optional secondary sealant layer may form the product contacting layer of the film structure 100 and may be about 0.5 mils or less. However, the secondary sealant layer may be any polymeric material that helps to protect the product from contacting the desiccant material.

As stated above, the barrier layer 114 may be a metal foil or Honeywell ACLAR® that may be any thickness to reduce the transmission of moisture through the film. The number of pinholes present in a metal foil, for example, is inversely related to the foil thickness. Therefore, a thicker foil tends to have fewer pinholes. However, if the desiccant material of the present invention is in the heat sealant layer 110, thinner foil or ACLAR® can be utilized in packages made from the film structure 100.

Metal foil or ACLAR® is typically utilized to provide an effective barrier against moisture transmission through a film structure. However, metal foil can be relatively expensive and difficult to process. Therefore, the desiccant sealant layer 110 is effective at reducing or eliminating the transmission of moisture that may pass through relatively thin metal foil. Desiccant films, therefore, add significant protection to the inside space of a package made from the film structure 100 in addition to the inherent barrier protection provided by metal foil. Barrier layers may be relatively thinner when a film structure incorporates a desiccant sealant layer into the film structure, thereby saving on cost.

FIG. 3 illustrates a package 200 made from a film structure of the present invention. Specifically, the package 200 is made from the film structure 100, as illustrated with respect to FIG. 2, described above. Specifically, the package 200 may comprise two film structures that are heat sealed together via a heat seal 202 that is formed around a perimeter of the package 200. Alternatively, the package 200 may comprise a single film structure that is folded and heat sealed around the perimeter of the package 200. The package 200 may further comprise a space 204 to contain a product 206. The product 206 may be sensitive to moisture, so that a desiccant material contained within the film structure or film structures reduces or eliminates the amount of water molecules within the space 204. A preferable product contained within the package 200 may be a diagnostic test strip or kit useful in the medical field. A single diagnostic test strip or instrument may be contained within the package 200 so that when opened and the diagnostic test strip or instrument is removed, there are no other test strips or instruments within the package 200 to be contaminated by moisture.

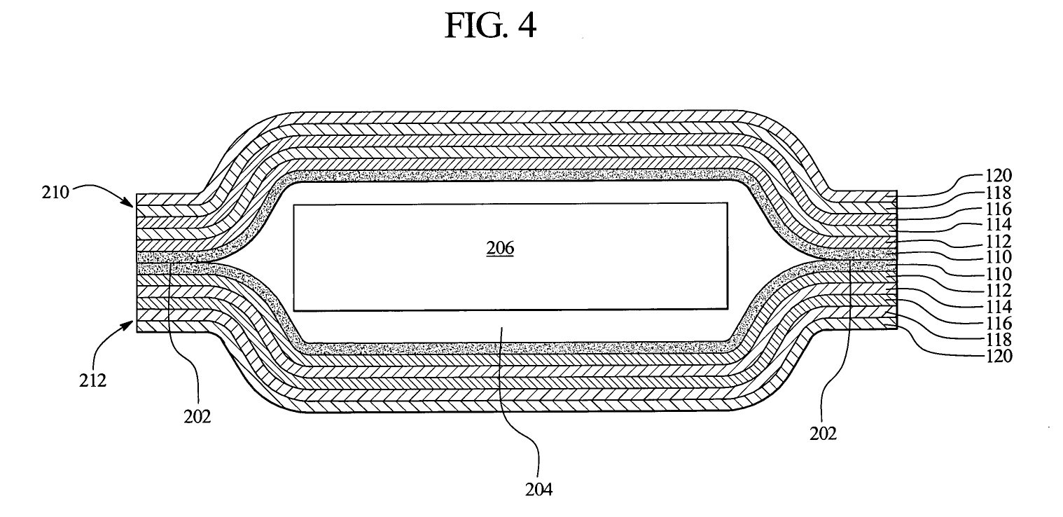

FIG. 4 illustrates a cross-section of the package 200 along line IV-IV, in an embodiment of the present invention. The cross-section shows two film structures 210, 212 that are heat sealed together at heat seals 202. The two film structures may be identical, and may comprise the same film layers as described above with respect to film structure 100. Specifically, the two film structure 210, 212 may comprise a plurality of layers: a sealant layer 110 of a polyolefinic material and a desiccant material; a tie or adhesive layer 112, comprising, for example, a blend of low density polyethylene and ethylene acrylic acid copolymer; a barrier layer 114 comprising, for example, a foil, ACLAR® or metallized material; a tie or adhesive layer 116 comprising, for example, a blend of low density polyethylene and ethylene acrylic acid copolymer; a printed or primer layer 118; and an outer or abuse layer 120 comprising, for example, PET. The product 206, such as a diagnostic test strip or instrument, is contained within the package 200 in the space 204.

While foil can reduce or effectively eliminate water transmission through film structures 210, 212 of the package 200, it cannot completely eliminate the transmission of moisture through the edges of the film structure. For example, FIG. 4 illustrates the cross-section of the package 200 along line IV-IV. As shown, the metal foil layer 114 of each film structure 210 and 212 are displaced from the portions of the film structure 210 and 212 that are heat sealed together. Therefore, there is an area 214 that is not protected by the metal foil layer 114 that may transmit water molecules into the space 204. If the desiccant material is incorporated into the heat sealant layer 110, then the desiccant material effectively blocks moisture from passing into the interior space 204 of the package 200 thereby protecting the moisture-sensitive product contained therein. In addition, if the desiccant material is in the heat sealant layer that contacts a moisture-sensitive product or other contacts the interior space 204, the desiccant material can remove moisture molecules that may be contained within the interior space 204.

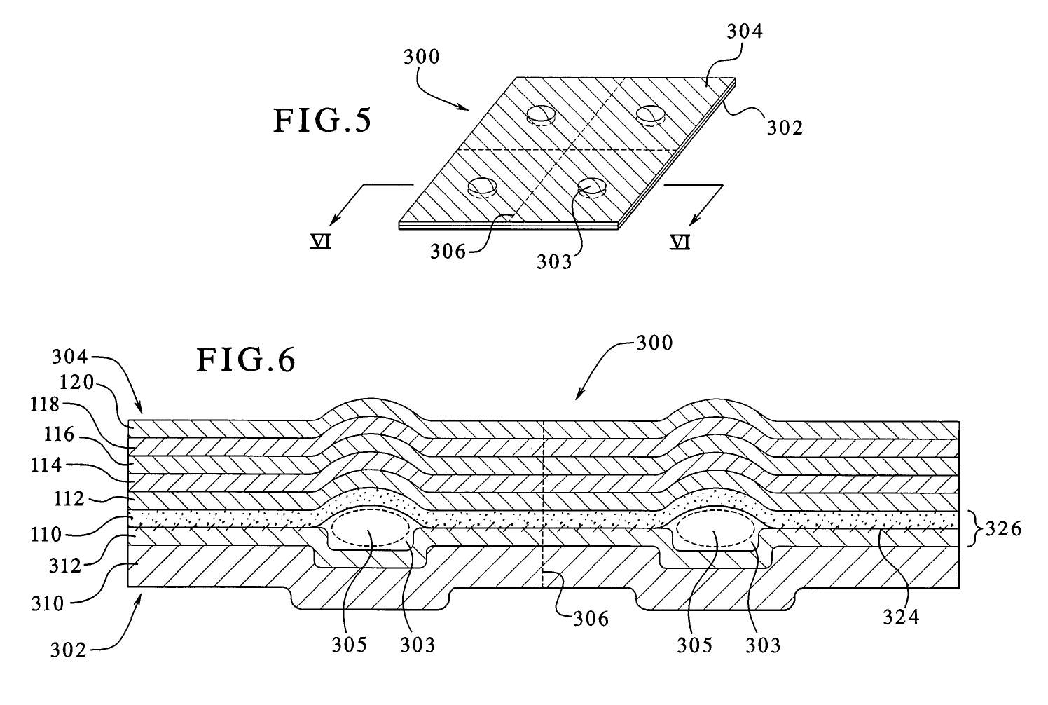

FIG. 5 illustrates a package 300 in an alternate embodiment of the present invention. More specifically, the package 300 may comprise a base structure 302 having multiple cavities 303 disposed therein for containing moisture-sensitive products therein. In addition, the base structure 302 may be formed by a polymeric material that provides an effective moisture barrier. For example, the material may comprise a film layer 310 (as shown in FIG. 6) made from ACLAR®, a high density fluorocarbon film having excellent water vapor barrier properties. In addition, the base structure 302 comprises cavities 303 for storing or otherwise containing the moisture-sensitive products 305. The cavities 303 may preferably be formed in the base structure 302 using a thermoforming process or any other process for forming the cavities 303 in the base structure 302. The moisture-sensitive products 305 may preferably be pharmaceutical or nutriceutical products, although any other moisture-sensitive product is contemplated by the present invention.

The base structure 302 may be heat-sealed to a lidstock structure 304. The lidstock structure may correspond to the film structure described above with reference to FIG. 2. Specifically, the heat sealant layer 110 of the lidstock structure 304 may be heat-sealed to a forming layer 312 of the base structure 302 that acts as a heat sealant layer for the base structure 302. The sealant layer 110 may comprise the desiccant material so that moisture cannot enter the cavities 303 along an edge 326 to damage any moisture-sensitive products contained therein. Moreover, the sealant layer 110 may further comprise a peelable seal component to allow a seal formed by heat sealing the desiccant lidstock structure 304 to the base structure 302 to be easily peelable. For example, the sealant layer 110 may comprise DuPont APPEEL® modified polymeric resin that allows the sealant layer 110 to separate from the forming layer 312 of the base structure 302 using digital pull-apart forces. Alternatively, both the heat sealant layer 110 of the lidstock structure 304 and the forming layer of the base structure 302 may comprise an amount of the desiccant material.

The package, as shown in FIGS. 5 and 6 may have perforations 306 such that the peelable film may only expose one cavity containing the moisture-sensitive product when the sealant film is peeled from the base structure. When the peelable sealant film structure is peeled from the base structure, the peelable sealant film structure may break at the perforations 306, thereby maintaining the barrier properties of the other products contained within the other cavities. The perforations 306 may alternately go all the way through the package 300 such that each individual cavity may be removed from the remaining cavities within the package by breaking the package 300 at the perforations 306.

Alternatively, the package 300, illustrated in FIG. 5 may have a lidstock structure 304, as described above with reference to FIG. 6, and a base structure that may be similar to the base structure 302, described above. However, the base structure 302 may further comprise a heat sealant layer disposed adjacent to the forming layer. The heat sealant layer may comprise a heat sealant material comprising modified EVA or modified EMA, such as DuPont APPEEL®, or BYNEL®, LDPE, EVA, ionomer, single site catalyzed polyethylene, or the like. In addition, the heat sealant layer of the base structure may comprise the desiccant sealant material, such as, for example, calcium oxide, or the like. Having the desiccant material in both the sealant layer 110 of the peelable sealant structure 304 and the base structure will make it more difficult for moisture to travel through the edge of the package to the cavities within the package. In addition, depending on the polymeric material that is utilized in the heat sealant layer of the base structure, the film may not be peelable as described above with respect to FIG. 6 when a heat-seal is formed between the lidstock structure 304 and the base structure 302. In this case, a notch or similar feature may be provided in the package that allows the package to be torn to gain access to the cavities disposed therein and, hence, the moisture-sensitive products contained therein.

In an alternative package, the lidstock structure 304 may not have a desiccant material disposed within the heat sealant layer. The desiccant material may be contained only within heat sealant layer of the base structure 302. For example, the base structure may comprise a layer of ACLAR® and a forming layer of PVC disposed adjacent the layer of ACLAR®. Disposed adjacent to the forming layer of PVC may be a heat sealant layer comprising an amount of the desiccant material blended with a polymeric material as described above that is useful for a heat sealant layer.

The base structure may have a forming layer on either or both sides of the ACLAR® layer. In addition, if a heat sealant layer is incorporated into the base structure, the heat sealant layer may be disposed directly adjacent to the ACLAR® layer or, as described above, may be disposed adjacent to a forming layer. Still further, a desiccant sealant layer may be provided adjacent an extrusion coated layer of APPEEL®, that may be disposed adjacent to a layer of ACLAR® that may be disposed adjacent to a layer of PVC.

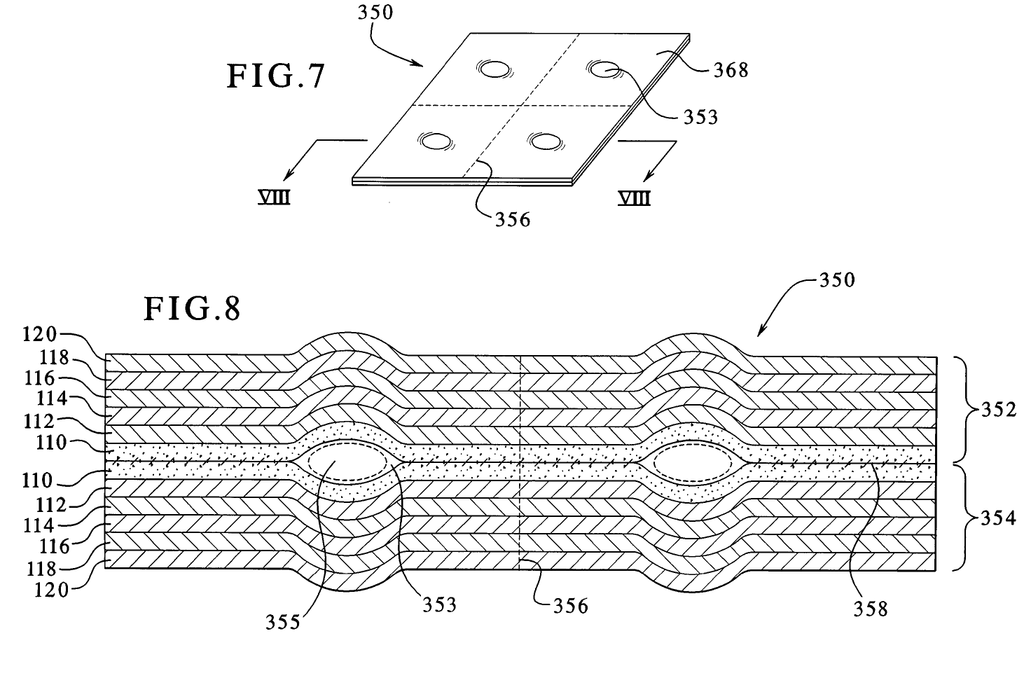

FIG. 7 illustrates an alternate package 350 of the present invention, whereby the base structure 302 is not utilized, but the package is formed by identical desiccant sealant film structures that are heat sealed together to form the package 350. Products may further be vacuum packed so that the products are held in place in individual cavities 353 by the desiccant sealant films forming completely around the moisture-sensitive product. This may be especially useful for brittle or otherwise easily-damaged products 355 that would break if allowed to freely sit within a package. In addition, perforations 356 may be contained within the package 350 so that individual cavities may be separated from the other cavities.

FIG. 8 illustrates a cross-section of the package shown in FIG. 7 along line VIII-VIII. As can be seen, the package consists of two identical desiccant sealant film structures 352, 354 that are placed in face to face relationship with each other and heat-sealed to form the cavities 353 to contain the products 355 therebetween. A heat seal 358 is provided around the products 355 such that each product is contained within an individual cavity. As noted above, the package 350 may be vacuum-packed so that the sealant film structures are tight around the products 355. Alternatively, the product may be loosely contained within a cavity formed by the sealant film structure that is disposed on a bottom of the package, similar to the package described in FIGS. 5 and 6.

Each sealant film structure 352, 354 may comprise the desiccant sealant layer 110, the first tie or adhesive layer 112, the barrier layer 114, the second tie or adhesive layer 116, the optional printed or primer layer 118 and the outer abuse layer 120. The desiccant sealant layer 110 may provide protection for the moisture sensitive product 355 contained with cavities 353 from moisture that may attempt to enter the package 350 along the edges of the package 350.

In addition, the film structures 352, 354 may be made having a peelable film component in the desiccant sealant layer 110, such that the two film structures 352, 354 are peelable from each other using digital pull-apart forces. Alternatively, notches 368 may be provided in the package 350 so that film structures 352, 354 may be torn and the moisture-sensitive product contained therein may be exposed. Alternatively, the film structure may be designed to be torn without the notches 368.

The film structures 100, 304, 352 and 354 may be made via cast coextrusion, extrusion coating and/or extrusion lamination, adhesive lamination, blown-film coextrusion or monolayer extrusion or any other film-making method generally known to those having ordinary skill in the art. Preferably, the heat sealant layer may be made by compounding the desiccant material into the polymeric resin, and extruding or coextruding via blown extrusion, cast extrusion, or extrusion lamination into a monolayer film or a multilayer film. The remainder of the film structures may be extrusion or adhesive laminated together with the monolayer film or multilayer film. The desiccant heat sealant layer can be laminated to the remainder of the film structure, including the barrier layer of the film structure.

As noted in the above paragraph, several methods exist for constructing an effective flexible package using the present invention. These methods include, but are not limited to:

1. Blown film monolayer extrusion or multilayer coextrusion of a desiccant sealant film that is extrusion laminated to a barrier material. The sealant film may be utilized as either the lidding, the base or both of the package. This method is preferred.

2. Blown film monolayer extrusion or multilayer coextrusion of a desiccant sealant film that is adhesive laminated to a barrier material with the use of adhesives and/or primers to bond the desiccant sealant film to the barrier layer. The film made by this method may be utilized as either the lidding, the base or both of the package.

3. Cast film monolayer extrusion or multilayer coextrusion of a desiccant sealant film that is extrusion laminated to a barrier layer. The film made by this method may be utilized as either the lidding, the base or both of the package.

4. Cast film monolayer extrusion or multilayer coextrusion of a desiccant sealant film that is adhesive laminated to barrier materials with the use of adhesives and/or primers to bond the desiccant sealant film to the barrier layer. The film made by this method may be utilized as either the lidding, the base, or both of the package.

5. Extrusion or coextrusion coating wherein the desiccant sealant layer and/or an adhesive layer are extrusion or coextrusion coated directly onto the barrier layer. The film made by this method may be utilized as either the lidding, the base, or both of the package.

Of course, any other methods of making films, film structures, and packages of the present invention may be utilized as may be apparent to one having ordinary skill in the art. Moreover, although film structures having barrier materials incorporated therein as a barrier layer of the film structures are preferred, other film structures such as those not having a barrier material or barrier layer may also be produced as apparent to one having ordinary skill in the art.

In addition, in an alternate embodiment of the present invention, the desiccant material may further be utilized to provide an indicator showing whether the desiccant material has reached its capacity. In addition, this may further provide an indication whether the package integrity has been compromised. Generally, desiccant materials become cloudy when they have absorbed water, especially when incorporated into films that are transparent. In addition, when the desiccant material absorbs moisture, the package becomes heavier, less transparent and more opaque. An image or a message may be provided in a film structure containing the desiccant material. When the image or message is obscured to a certain point, such as when the image or message cannot be viewed anymore because of the cloudiness of the package, an individual may know that the desiccant material has reached its capacity, or is close to reaching its capacity, thereby indicating that the package, and therefore the product, is relatively old, or the package has been compromised and moisture has entered the package. Alternatively, the package may contain a moisture indicator visible through at least a portion of the package, such as a window or the like, to form or change colors, thereby indicating the presence of excess moisture.

### EXAMPLES

The following examples are illustrative of preferred embodiments of the present invention, as described above, and are not meant to limit the invention in any way.

### Example 1

The following Table 1 illustrates preferred materials and gauges for the film structure 100, as described above and illustrated with respect to FIG. 2.

TABLE 1

| Material | Gauge |
|---|---|
| PET | 0.48 mils |
| INK | 0.1 #/ream |
| LDPE/EAA Coextrusion | 0.5 mils |
| Foil | 0.35 mils |
| LDPE/EAA blend | 0.5 mils |
| LDPE/CaO blend | 1.5 mils |

### Example 2

The following Table 2 illustrates preferred materials and gauges for the film structure 100, as described above and illustrated with respect to FIG. 2, in an alternate embodiment of the present invention.

TABLE 2

| Material | Gauge |
|---|---|
| PET | 0.48 mils |
| INK | 0.1 #/ream |
| LDPE/EAA Coextrusion | 0.5 mils |
| Foil | 0.35 mils |
| LDPE/EAA blend | 0.5 mils |
| LDPE/CaO blend | 2.5 mils |

### Example 3

Example 3 is a preferred embodiment of the package 200, described above and illustrated with respect to FIG. 3. The package may be made from film structures noted above, and preferably with respect to Examples 1 and/or 2. Specifically, the package 200 may be for diagnostic test strips or instruments. Each package may be about 5.25 in. long and about 2.25 in. wide. The heat seals that are created around the perimeter of the packages are about 0.25 in. wide. Taking into consideration the heat seals, each package would have a total exposed internal surface of about 16.6 in.²

### Examples 4-6

The following table 3 illustrates preferred film structures and gauges for a sealant film layer that is extruded as a monolayer film or coextruded with a second layer, such as a tie or adhesive layer, and is then laminated to other film layers, such as a barrier layer, another tie or adhesive layer, an optional printed or primer layer, and an abuse layer, to form the film structures 304, 352 or 354, as described above with reference to FIGS. 5-8, in alternate embodiments of the present invention. Each of the sealant films is made via a blown extrusion method, although other methods are available, such as cast extrusion.

TABLE 3

| Example | Film materials | Gauge |
|---|---|---|
| 4 | 39% DuPont Appeel 2044 | 2.0 mil |
| | 60% Ampacet X101499 LLDPE of | |
| | 60% by weight calcium oxide | |
| | 1% Ampacet slip 7012125 | |
| 5 | 49% DuPont Appeel 1184 | 2.0 mil |
| | 50% Ampacet X101499 LLDPE of | |
| | 60% by weight calcium oxide | |
| | 1% Ampacet slip 7012125 | |
| 6 | 59% DuPont Appeel 1181 | 2.5 mil |
| | 40% Ampacet X101499 LLDPE of | |
| | 60% by weight calcium oxide | |
| | 1% Ampacet slip 7012125 | |

After the sealant films are made using blown extrusion, the films should be wrapped immediately with a moisture barrier material to avoid being contaminated by moisture in the atmosphere.

### Example 7

Table 4 illustrates an embodiment of the present invention, whereby the sealant film layer, described above as Example 4, is laminated to other film layers to form a sealant film structure.

TABLE 4

| Film layer | Materials | Gauge |
|---|---|---|
| Inner heat | Example 4, described above. | 2.0 mils |
| sealant layer | | |
| First tie or | EAA/LDPE Coextrusion | 0.5 mils |
| adhesive layer | | |
| Barrier layer | Foil | 70 gauge |
| Second tie or | EAA/LDPE Coextrusion | 0.5 mils |
| adhesive layer | | |
| Print layer | Ink | 0.1 #/ream |
| Outer abuse | PET | 48 gauge |
| layer | | |

The peel strength was measured as 300 grams with a heat seal made at 320° F. at 50 psi for 1.0 second.

### Example 8

Table 5 illustrates an embodiment of the present invention, whereby the sealant film layer, described above in Example 5, is laminated to other film layers to form a sealant film structure.

TABLE 5

| Film layer | Materials | Gauge |
|---|---|---|
| Inner heat sealant | Example 5, described above. | 2.0 mils |
| layer | | |
| First tie or | EAA/LDPE Coextrusion | 0.5 mils |
| adhesive layer | | |
| Barrier layer | Foil | 70 gauge |
| Second tie or | EAA/LDPE Coextrusion | 0.5 mils |
| adhesive layer | | |
| Print layer | Ink | 0.1 #/ream |
| Outer abuse layer | PET | 48 gauge |

The peel strength was measured as 600 grams with a heat seal made at 320° F. at 50 psi for 1.0 second.

### Example 9

Table 6 illustrates an embodiment of the present invention, whereby the sealant film layer, described above in Example 6, is laminated to other film layers to form a sealant film structure.

TABLE 6

| Film layer | Materials | Gauge |
|---|---|---|
| Inner heat | Example 6, described above. | 2.5 mils |
| sealant layer | | |
| First tie or | EAA/LDPE Coextrusion | 0.5 mils |
| adhesive layer | | |
| Barrier layer | Foil | 70 gauge |
| Second tie or | EAA/LDPE Coextrusion | 0.5 mils |
| adhesive layer | | |
| Print layer | Ink | 0.1 #/ream |
| Outer abuse | PET | 48 gauge |
| layer | | |

The peel strength was measured as 900 grams with a heat seal made at 320° F. at 50 psi for 1.0 second.

### Example 10

Each of the sealant film structures, described above with reference to Examples 7-9, can be utilized as lidding material and may be heat-sealed to another film structure, such as a base structure of a layer of ACLAR® and one or more layers of PVC, with an alternative heat sealant layer, which has been thermoformed by the application of heat and/or pressure to form individual cavities for containing moisture-sensitive pharmaceutical or nutriceutical products.

### Example 11

Alternatively, each of the sealant film structures, described above with reference to Examples 7-9, can be heat-sealed to identical film structures to provide packages having spaces therein for moisture-sensitive products, such as pharmaceutical or nutriceutical products.

### Example 12

Table 7 illustrates an alternative film structure that may be heat sealed to the sealant film structures described above with reference to Examples 7-9. The sealant film structures can be heat sealed to a base structure having a heat sealant layer comprising an amount of a desiccant material.

TABLE 7

| Film layer | Materials | Gauge |
|---|---|---|
| Inner heat | Example 6, described above | 2.5 mils |
| sealant layer | | |
| Extrusion | APPEEL ® | .5 mils |
| Coating | | |
| Forming layer | PVC | 6 mils |
| Barrier layer | ACLAR ® | 1 mil |

Alternatively, the forming layer of PVC and the barrier layer of ACLAR® may be switched. In addition, the extrusion coating layer of APPEEL® may be replaced with an adhesive layer such that the inner heat sealant layer may be adhesive laminated to the remainder of the film structure.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A first film structure comprising:
a plurality of layers wherein a first layer comprises a desiccant material blended therein and further wherein said first layer comprises a material for making a peelable seal when the first layer is heat-sealed to a second film structure.

2. The first film structure of claim 1 wherein said desiccant material is a chemical desiccant material.

3. The flexible film structure of claim 1 wherein said desiccant material is selected from the group consisting of calcium oxide, magnesium oxide, barium oxide, barium hydroxide, strontium oxide, aluminum oxide, partially hydrated aluminum oxide, magnesium sulfate, sodium phosphate di-basic, ammonium chloride, potassium carbonate, potassium aluminum disulfate, magnesium chloride, diammonium sulfate, sodium nitrate, calcium chloride, calcium sulfate, sodium chloride, potassium bromide, molecular sieves, clays and blends of these materials.

4. The first film structure of claim 1 wherein said first film structure further comprises a barrier layer wherein said barrier layer comprises a material selected from the group consisting of metal foil, nylon, high density polyethylene, oriented or cast polypropylene, metallized oriented polypropylene, oriented polyester and high density fluorocarbon polymer.

5. The first film structure of claim 4 further comprising a first tie layer of a polymeric material disposed between said barrier layer and said sealant layer.

6. The flexible film structure of claim 5 wherein said first tie layer of polymeric material comprises ethylene acrylic acid copolymer.

7. The flexible film structure of claim 1 further comprising:
a second layer of a polymeric material.

8. The flexible film structure of claim 7 wherein said second layer is an outer layer of the first film structure and further comprises a polymeric material selected from the group consisting of polyethylene terephthalate, oriented polypropylene, polyethylene, nylon, foil, metallized substrates and high density fluorocarbon polymer.

9. The first film structure of claim 7 wherein said first layer is an inner heat sealant layer and further wherein said first flexible film structure comprises a barrier layer disposed between the outer layer and the inner heat sealant layer and further comprising a second tie layer disposed between said outer layer and said barrier layer.

10. The first film structure of claim 9 further comprising:
a first tie layer disposed between said inner heat sealant layer and said barrier layer.

11. The first film structure of claim 10 further comprising:
a second tie layer disposed between said outer layer and said barrier layer.

12. The first film structure of claim 10 wherein said first and second tie layers each comprise ethylene acrylic acid copolymer.

13. A package comprising:
a first film structure wherein said first film structure comprises a plurality of layers wherein a first layer comprises a first desiccant material;
a second film structure heat sealed to said first film structure; and
a space inside the package for a moisture-sensitive product,
wherein said package further comprises a material for making a peelable seal between said first film structure and said second film structure when said first film structure is heat-sealed to said second film structure.

14. The package of claim 13 wherein said desiccant material is a chemical desiccant material.

15. The package of claim 13 wherein said desiccant material is selected from the group consisting of calcium oxide, magnesium oxide, barium oxide, barium hydroxide, strontium oxide, aluminum oxide, partially hydrated aluminum oxide, magnesium sulfate, sodium phosphate di-basic, ammonium chloride, potassium carbonate, potassium aluminum disulfate, magnesium chloride, diammonium sulfate, sodium nitrate, calcium chloride, calcium sulfate, sodium chloride, potassium bromide, molecular sieves, clays and blends of these materials.

16. The package of claim 13 wherein said second film structure comprises a heat sealable layer for heat sealing to the first layer of said first flexible film structure.

17. The package of claim 13 wherein said second film structure comprises a plurality of layers wherein a first layer of said second film structure comprises a second desiccant material wherein said first layer of said first film structure and said first film layer of said second film structure are heat-sealed together.

18. The package of claim 13 wherein said first film structure comprises:
an outer layer of polyethylene terephthalate;
a core layer of a barrier material forming a barrier layer;
a first tie layer disposed between said first layer and said barrier layer; and
a second tie layer disposed between said barrier layer and said outer layer.

19. The package of claim 16 wherein said second film structure comprises a second layer of a polymeric material.

20. The package of claim 19 wherein said second film structure is thermoformed to form said space for said second moisture-sensitive product.

21. The package of claim 13 wherein said first film layer of said first film structure comprises said material for making the peelable seal between said first film structure and said second film structure when said first film structure is heat-sealed to said second film structure.

22. The package of claim 13 wherein said second film structure comprises said material for making the peelable seal between said first film structure and said second film structure when said first film structure is heat-sealed to said second film structure.

23. A method of making a first film structure comprising the steps of:
extruding a first film layer comprising a blend of a polymeric material, a desiccant material, and a material for making a peelable seal when the first film structure is heat-sealed to a second film structure; and
laminating said film layer to a second film layer.

24. The method of claim 23 wherein said first film layer is extruded via a blown film extrusion process.

25. The method of claim 23 wherein said first film layer is extruded via a cast extrusion process.

26. The method of claim 23 wherein said first film layer is adhesively laminated to said second film layer.

27. The method of claim 23 wherein said first film layer is extrusion laminated to said second film layer.

28. The method of claim 23 further comprising the step of:
coextruding a tie layer with said first film layer comprising the blend of the polymeric material, the desiccant material, and the material for making a peelable seal when the first film structure is laminated to a second film structure;
laminating said tie layer and said first film layer to said second film layer.

29. The method of claim 23 wherein said second film layer comprises a barrier material to form a barrier layer.

30. The method of claim 29 wherein said barrier layer comprises a material selected from the group consisting of metal foil, nylon, high density polyethylene, oriented polypropylene, metallized oriented polypropylene, metallized polyester and high density fluorocarbon polymer.

31. A package having a space therein for a moisture-sensitive product made from the first film structure made via the method of claim 23 wherein said first film layer is a heat sealant layer and wherein said heat sealant layer is heat-sealed to said second film structure.

32. A method of making a flexible film structure, comprising the step of:
extrusion coating a film layer comprising a blend of a polymeric material, a desiccant material, and a material for making a peelable seal when the first film structure is laminated to a second film structure.

33. The method of claim 32 wherein said second film layer is a moisture barrier layer.

34. The method of claim 33 wherein said moisture barrier layer comprises a material selected from the group consisting of metal foil, nylon, high density polyethylene, oriented polypropylene, metallized oriented polypropylene, metallized polyester and high density fluorocarbon polymer.

35. The method of claim 32 wherein said first film layer comprising the blend of the polymeric material, the desiccant material, and the material for making a peelable seal when the first film structure is laminated to a second film structure.

36. A package having a space therein for a moisture-sensitive product made from the film structure made via the method of claim 32 wherein said first layer is a heat sealant layer and further wherein said heat sealant layer is heat sealed to a second film structure.

37. A first film structure comprising:
a plurality of layers wherein a first layer comprises a desiccant material blended therein;
a second layer disposed adjacent to said first layer forming an inner sealant layer; and
a peelable film component disposed within said first or second layer of said film structure.

38. The first film structure of claim 37 wherein said desiccant material is a chemical desiccant material.

39. The flexible film structure of claim 37 wherein said desiccant material is selected from the group consisting of calcium oxide, magnesium oxide, barium oxide, barium hydroxide, strontium oxide, aluminum oxide, partially hydrated aluminum oxide, magnesium sulfate, sodium phosphate di-basic, ammonium chloride, potassium carbonate, potassium aluminum disulfate, magnesium chloride, diammonium sulfate, sodium nitrate, calcium chloride, calcium sulfate, sodium chloride, potassium bromide, molecular sieves, clays and blends of these materials.

40. The first film structure of claim 37 wherein said first film structure further comprises a barrier layer wherein said barrier layer comprises a material selected from the group consisting of metal foil, nylon, high density polyethylene, oriented or cast polypropylene, metallized oriented polypropylene, oriented polyester and high density fluorocarbon polymer.
